(19) United States
(12) Patent Application Publication
(10) Pub. No.: US 2025/0055619 A1
(43) Pub. Date: Feb. 13, 2025

(54) CONFIGURATION OF PROTOCOL DATA UNIT SET IMPORTANCE (PSI)-BASED DISCARD

(71) Applicant: Nokia Technologies Oy, Espoo (FI)

(72) Inventors: Benoist Pierre SEBIRE, Tokyo (JP); Abolfazl Amiri, Aalborg (DK)

(21) Appl. No.: 18/775,120

(22) Filed: Jul. 17, 2024

(30) Foreign Application Priority Data
Aug. 9, 2023 (FI) 20235884

(51) Int. Cl. H04L 5/00; H04W 28/06; H04W 28/08

(52) U.S. Cl. CPC H04L 5/0044; H04W 28/06; H04W 28/0992

(57) ABSTRACT

A method includes transmitting, by a network apparatus to a user equipment (UE) based on a first condition, a first command to activate a protocol data unit set importance (PSI)-based discard at the UE, where the PSI-based discard includes discarding a protocol data unit (PDU) set based on a PSI level of the PDU set satisfying a PSI criterion, and where the PDU set includes one or more PDUs carrying a payload of one unit of information at an application level; and transmitting, by the network apparatus to the UE based on a second condition, a second command to cancel the PSI-based discard at the UE.

### FIELD

Various example embodiments relate generally to wireless networks and, more particularly, to configuring protocol data unit set importance (PSI)-based discard.

### BACKGROUND

Wireless networking provides significant advantages for user mobility. A user's ability to remain connected while on the move provides advantages not only for the user, but also provides greater efficiency and productivity for society as a whole. As user expectations for, e.g., extended reality (XR) services, user's quality of experience (QoE), and high-traffic handling, become more demanding, technology for wireless networking must also keep pace with such expectations. Accordingly, there is continuing interest in improving wireless networking technology.

### SUMMARY

In accordance with aspects of the present disclosure, a method includes transmitting, by a network apparatus to a user equipment (UE) based on a first condition, a first command to activate a protocol data unit set importance (PSI)-based discard at the UE, where the PSI-based discard includes discarding a protocol data unit (PDU) set based on a PSI level of the PDU set satisfying a PSI criterion, and where the PDU set includes one or more PDUs carrying a payload of one unit of information at an application level; and transmitting, by the network apparatus to the UE based on a second condition, a second command to cancel the PSI-based discard at the UE.

In an aspect of the method, the payload in the PDU set for the PSI-based discard is associated with an extended reality application.

In an aspect of the method, the transmitting the second command to cancel PSI-based discard includes transmitting, by the network apparatus to the UE, a control PDU including a flag value indicating the second command.

In an aspect of the method, the control PDU is a designated control PDU specific for PSI-based discard cancellation.

In an aspect of the method, the control PDU further includes a timer value indicating a duration during which the PSI-based discard is to be cancelled.

In an aspect of the apparatus, the transmitting the second command to cancel PSI-based discard includes transmitting, by the network apparatus to the UE, a control PDU including a threshold PSI value set to a highest allowable PSI value to indicate the second command to cancel the PSI-based discard.

In an aspect of the method, the transmitting the second command to cancel PSI-based discard includes transmitting, by the network apparatus to the UE, a packet data convergence protocol (PDCP) control PDU including the second command.

In an aspect of the method, the first command includes an indication of the PSI criterion including a threshold PSI and an indication of a duration during which the PSI-based discard is to be activated.

In an aspect of the method, the second command further overrides the duration during which the PSI-based discard is activated.

In accordance with aspects of the present disclosure, a method including receiving, by a user equipment (UE), a first command to activate a protocol data unit set importance (PSI)-based discard at the UE; discarding, by the UE in response to the first command, a first protocol data unit (PDU) set based at least on a PSI level of the first PDU set satisfying a PSI criterion, where the first PDU set includes one or more PDUs carrying a payload of one unit of information at an application level; receiving, by the UE, a second command to cancel the PSI-based discard at the UE; and transmitting, by the UE in response to the second command, a second PDU set irrespective of a PSI level of the second PDU set satisfy the PSI criterion.

In an aspect of the method, the payload in the discarded first PDU set is associated with an extended reality application.

In an aspect of the method, the receiving the second command to cancel PSI-based discard includes receiving, by the UE, a control PDU including a flag value indicating the second command.

In an aspect of the method, the control PDU is a designated control PDU specific for PSI-based discard cancellation.

In an aspect of the method, the control PDU further includes a timer value indicating a duration during which the PSI-based discard is to be cancelled.

In an aspect of the method, the receiving the second command to cancel PSI-based discard includes receiving, by the UE, a control PDU including a threshold PSI value set to a highest allowable PSI value to indicate the second command to cancel of the PSI-based discard.

In an aspect of the method, the receiving the second command to cancel PSI-based discard includes receiving, by the UE, a packet data convergence protocol (PDCP) control PDU including the second command.

In an aspect of the method, the receiving the second command to cancel PSI-based discard includes receiving, by the UE, an indication of the PSI criterion including a threshold PSI and an indication of a duration during which the PSI-based discard is to be activated.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE), according to one illustrated aspect of the disclosure;

FIG. 2 is a diagram of an example packet transmission approach with protocol data unit set importance (PSI) information, according to one illustrated aspect of the disclosure;

FIG. 3 is a diagram of an example embodiment of operations for packet transmission with PSI-based discard configurations, according to one illustrated aspect of the present disclosure;

FIG. 4 is an example packet including an indication of a PSI-based discard cancellation, according to one illustrated aspect of the present disclosure;

FIG. 5 is an example packet including an indication of a PSI-based discard cancellation, according to one illustrated aspect of the present disclosure;

FIG. 6 is an example packet including an indication of a PSI-based discard cancellation, according to one illustrated aspect of the present disclosure;

FIG. 7 is a flow diagram of example operations of a network apparatus that controls PSI-based discard for uplink transmission (UL) transmission at a UE, according to one illustrated aspect of the present disclosure;

FIG. 8 is a flow diagram of example operations of a UE that performs UL transmissions with PSI-based discard controlled by a network, according to one illustrated aspect of the present disclosure; and

FIG. 9 is a diagram of example embodiment of components of a UE or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

Recent advancements in wireless communication technologies, such as 5G NR, can provide fast connectivity speeds, high bandwidths, and ultra-reliable, low-latency communications. These advancements can enable a wide variety of applications and/or services.

The terms “service” and “application” may be used interchangeably herein, such that a description referring to one of the terms shall be treated as though the description also referred to the other term.

Certain services, such as extended reality (XR) applications, video streaming, cloud-based gaming, may have special traffic characteristics that are different from traditional applications. For example, one unit of information at an application level (e.g., a video frame or a video slice from an encoder) may be carried in a set of protocol data units (PDUs), which may be referred to as a PDU set. At a receiver side, the entire set of PDUs may be needed by the application (e.g., a decoder) to use the corresponding unit of information. Thus, if one or more PDUs in a PDU set cannot be successfully transmitted by a transmitter and received by a respective receiver, the entire set of PDUs may not be used by a respective application at the receiver side. Accordingly, in some scenarios (e.g., during traffic congestion), when one of the PDUs in the set is known to be lost or cannot be transmitted (e.g., within a certain amount of time), it may be beneficial to discard remaining PDUs in the PDU set at the transmitter to free up radio resource(s) for other transmission.

Another special traffic characteristic of those services is that one PDU set may have a higher importance level than another PDU set at an application level. For example, a media streaming application may generate data or information in units of I-frames, B-frames, and P-frames, where each of these frames may correspond to a PDU set. An I-frame is a reference frame (a complete frame on its own). A P-frame may carry changes from a previous frame. A B-frame may carry changes between the current frame and a previous frame and/or changes between the current frame and a following frame. Because a P-frame or a B-frame may rely on a reference frame (an I-frame) for decoding, a PDU set corresponding to an I-frame may be more important than a PDU set corresponding to a P-frame or a B-frame.

Accordingly, it may be desirable to add traffic characteristic awareness (e.g., XR-awareness) at a transmitter side to enhance capacity. This awareness may be achieved via several traffic assistance information. One of the traffic assistance information elements may be a PDU set importance (PSI) which can be used for discarding PDU set(s) (e.g., XR packets) under a certain network condition (e.g., in the case of traffic congestion). A PSI may identify the relative importance of a PDU set compared to other PDU sets within a quality of service (QOS) flow. That is, different PDU sets in a QoS flow can have different PSIs.

In some examples, PDU set-based QoS handling in a downlink (DL) direction can be performed as defined by 3rd Generation Partnership Project (3GPP) TS 23.501 v18.2.2 (2023-07) (“TS 23.501 document”) section 5.37.5.2, which is hereby incorporated by reference herein in its entirety. For instance, a PDU session anchor (PSA) user plane function (UPF) (e.g., at a core network) may identify PDUs that belong to PDU sets and determine PDU set information for each of the PDU sets. The PDU set information may include, for example, but not limited to, a PDU set sequence number, an indication of an end PDU of the respective PDU set, PDU sequence numbers within a PDU set, a PDU set size in bytes, and a PSI. In some instances, the PSA UPF may send the PDU sets along with corresponding PDU set information to a respective next generation-radio access network (NG-RAN). For instance, the PSA UPF may transmit a PDU set to the NG-RAN using a general packet radio service (GPRS) tunnelling protocol (GTP) and may include the PDU set information in a GTP-user plane (GTP-U) header. In some instances, the NG-RAN may use the priority level across QoS flows and PSI within a QoS flow for PDU set level packet discarding, for example, in the presence of congestion. The priority level associated with a QoS flow may indicate a priority in scheduling resources among QoS flows and may be used to differentiate between QoS flows of the same UE and/or from different UEs, for example, as defined in the TS 23.501 document section 5.7.3.3.

In some examples, in addition to considering the PSI within a QoS flow, the NG-RAN may also consider the relative PSI across QoS flows of the same priority level when determining which PDU set needs to be discarded, which may be dependent on the implementation and configuration of an operator.

In some examples, PDU set information can be different for different PDU sets within a QoS flow.

In some examples, an NG-RAN may perform PDU set-based discard operations. For instance, when PDU set integrated handling information (PSIHI) is set for a QoS flow, as soon as one PDU of a PDU set is known to be lost, the remaining PDUs of that PDU set can be considered as no longer needed by the application and may be subject to discard operation at the transmitter to free up radio resource(s). However, in some instances where forward error correction (FEC) is applied, active discarding of PDUs, when a large enough number of PDUs have already been transmitted and FEC performs recovery without the remaining PDUs, may trigger an increase of FEC packets.

In some examples, PDU set-based discard may also be beneficial for transmission in an uplink (UL) direction. For instance, a UE may be configured with PDU set-based discard operation for a specific data radio bearer (DRB). When configured, the UE may discard all packets (PDUs) in a PDU set when one PDU belonging to this PDU set is discarded, e.g., based on a discard timer expiry.

In some scenarios (e.g., during traffic congestion), it may be desirable to perform PDU set-based discard further based on a respective PSI level of a PDU set. For instance, a transmitter may discard PDU set(s) with lower importance and continue to transmit PDU set(s) with higher importance.

As used herein, the term “PSI-based discard” may refer to discarding a PDU set based on a PSI level of the respective PDU set.

In some examples, PSI-based discard can be performed at a network side and at a UE side. Because network condition and/or traffic condition may change dynamically and, in some scenarios, a UE may be unaware of the network and/or traffic condition, it may be desirable for a network to dynamically activate and deactivate PSI-based discard at a UE according to network and/or traffic condition.

Aspects of the present disclosure relate to configuring a PSI-based discard configuration at a UE. In an aspect, a network apparatus (e.g., a network node in a RAN) may transmit, to a UE based on a first condition, a first command to activate a PSI-based discard at the UE. The PSI-based discard includes discarding a PDU set based on a PSI level of the PDU set satisfying a PSI criterion (e.g., a PSI threshold). The PDU set includes one or more PDUs carrying a payload of one unit of information at an application level. In some instances, the payload in the PDU set for the PSI-based discard is associated with an XR application. The network apparatus may transmit (e.g., at a later time), to the UE based on a second condition, a second command to cancel the PSI-based discard at the UE. In an example, the first network condition may be a congestion condition, and the second network condition may be a non-congestion condition.

The network apparatus may transmit the second command in a variety of ways. In one aspect, as part of transmitting the second command, the network apparatus may transmit a control PDU including a flag value (e.g., a one-bit value) indicating the second command. In some instances, the control PDU may be a designated control PDU specific for PSI-based discard cancellation. In some instances, the control PDU may further include a timer value indicating a duration during which the PSI-based discard is to be cancelled. In another aspect, as part of transmitting the second command, the network apparatus may transmit a control PDU including a threshold PSI value set to a highest allowable PSI value to serve as the second command to cancel of the PSI-based discard. In aspects, as part of transmitting the second command, the network apparatus may transmit a packet data convergence protocol (PDCP) control PDU including the second command. In aspects, the network apparatus may transmit the first command and the second command to the UE in the same communication.

In aspects, in response to the first command (the PSI-based discard activation), the UE may discard a first PDU set based on a PSI level of the PDU satisfying the PSI criterion. In response to the second command (the PSI-based discard cancellation), the UE may transmit a second PDU set irrespective of the second PDU set satisfying the PSI criterion. The transmitting the second PDU set may involve a PDCP entity of the UE submitting the second PDU set to a lower layer (e.g., a radio link control (RLC) entity of the UE).

In aspects, the network apparatus may further transmit a PDU set discard timer value, for example, via radio resource control (RRC) signaling. The PDU set discard timer value may specify a duration for configuring a PDU set discard timer, which the UE (e.g., a PDCP entity of the UE) may start upon receiving a PDU set from an application layer, and upon an expiry of the PDU set discard timer, the UE may discard the received PDU set.

In aspects, as part of transmitting the first command, the network apparatus may transmit a control PDU that includes an indication of an activation duration, during which the PSI-based discard by the UE is to be activated, and that includes an indication of the PSI criterion (e.g., which includes a threshold PSI for the PSI-based discard). In aspects, the second command (PSI-based discard cancellation) can override the activation duration. For instance, the network apparatus may transmit the second command before the end of the activation duration to cancel the PSI-based discard at the UE. In another aspect, as part of transmitting the first and second commands to the UE in the same communication, the network apparatus may transmit a control PDU that includes an indication of the PSI criterion and an indication of an activation duration during which the PSI-based discard by the UE is to be activated, where the start of the activation duration may serve as the first command and the end of the activation duration may serve as the second command. Such and other aspects will be described in more detail later herein.

Aspects of the present disclosure may enable a network to control when to cancel PSI-based discard at a UE. Such cancellation behavior can be important as it governs whether the UE may keep discarding certain PDU sets based on their respective PSI values or go back to a state of not discarding based on a PSI criterion. For example, having a UE continue with PSI-based discard, at times when a network has changed conditions (e.g., less congestion) and can support the UE transmissions, may be undesirable as the PSI-based discard can unnecessarily downgrade a user's QoE (e.g., for XR services). Accordingly, having dynamic PSI-based discard activation and cancellation can improve a user's QoE (e.g., for XR services).

The present disclosure may use the term “serving network device” to refer to a network node or network device (or a portion thereof) that services a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

The present disclosure uses 5G NR as an example of a wireless network and may use smartphones and/or extended reality headsets as an example of UEs. It is intended and shall be understood that such examples are merely illustrative, and the present disclosure is applicable to other wireless networks and user equipment.

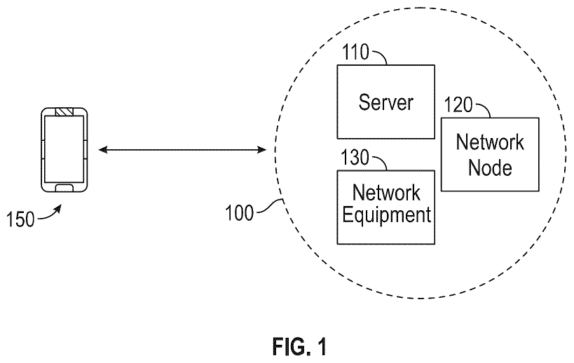

FIG. 1 is a diagram depicting an example of wireless networking between a network system 100 and a user equipment (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3GPP. However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP TS 38.300 V16.6.0 (2021-06) section 3.2, which is hereby incorporated by reference herein.

A gNB supports various protocol layers, e.g., Layer 1 (L1)-physical layer, Layer 2 (L2), and Layer 3 (L3).

The layer 2 (L2) of NR is split into the following sublayers: Medium Access Control (MAC), RLC, Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021-06) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

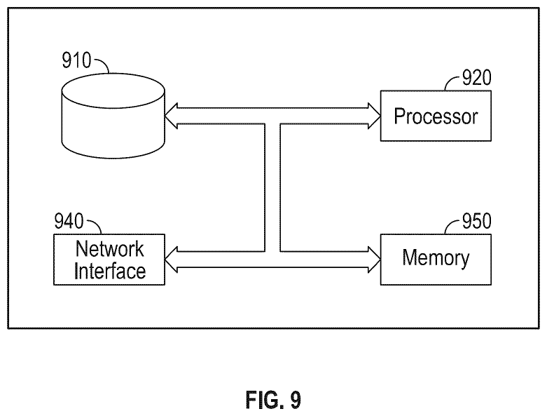

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 9 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The UE 150 may be or include a wireless or mobile device, an apparatus with a radio interface to interact with a RAN (radio access network), a smartphone, an in-vehicle apparatus, an Internet of Things (IoT) device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 9. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

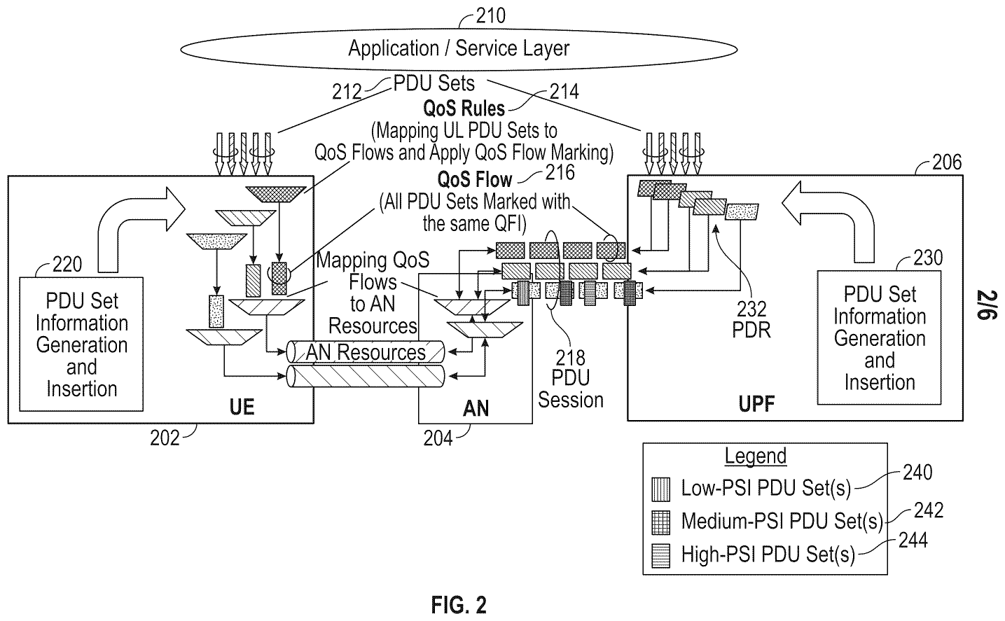

FIG. 2 is a diagram of an example packet transmission approach with PSI information, according to one illustrated aspect of the disclosure. A 5G NR network may be described as an example of the network system 100, and it is intended that aspects of the following description shall be applicable to other types of network systems, as well. In an aspect, the network system 100 may utilize the packet transmission approach as shown in FIG. 2. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be logical connections over service-based interfaces such that any component may communicate with any other component. In this manner, any component may act as a service “producer,” for any other component that is a service “consumer,” to provide services for network functions.

As shown in FIG. 2, the packet transmission approach may include a UE 202, an access node (AN) 204 at a RAN of the network system, and an UPF 206 at a core network of the network system. For example, the UE 202 may correspond to the UE 150, the AN 204 may correspond to the network node 120, and the UPF 206 may be a component at a core network of the network system 100. As used herein, and unless indicated otherwise, the terms “network system”, “network side”, and “network” (where used alone) may include both RAN components and core network components, e.g., both the AN 204 and the UPF 206. A PDU session 218 may be established between the UE 202 and the network (e.g., the UPF 206) to serve an application (or service) 210 to the UE 202. In an example, the application 210 may be an XR application. In the illustrated example of FIG. 2, the PDU session 218 supports three QoS flows 216. However, a PDU session may support any suitable number of QoS flows (e.g., 1, 2, 4, 5, 6 or more).

The application 210 may generate PDU sets 212. Each PDU set 212 may include one or more PDUs carrying a payload of one unit of information at the application 210. The application 210 may have one part (e.g., a server application) at the network side and another part (e.g., a client application) at the UE side (where the server application and the client application may be in communication with each other via the UPF 206, the AN 204, and the UE 202 in the network system). At the network side, the application 210 may send the PDU sets 212 to the UPF 206 for transmission to the UE 202 in a DL direction. At the UE side, the application 210 may configure the PDU sets 212 for the UE 202 to transmit to the network (e.g., the AN 204 and the UPF 206) in a UL direction.

In the DL direction, the UPF 206 may apply packet detection rules (PDRs) 232 to classify the incoming DL PDU sets 212 (from the server application 210) for QoS flows 216. Each QoS flow 216 may be identified by a QoS flow identifier (QFIs). In an example, the classification may include encapsulating or marking the DL PDU sets 212 with respective QFIs. Additionally, the UPF 206 may include a PDU set information generation and insertion component 230. The PDU set information generation and insertion component 230 may generate PDU set information for each DL PDU set 212. The PDU set information may include, for example, but not limited to, a PDU set sequence number, an indication of an end PDU of the respective PDU set, PDU sequence numbers within a PDU set, a PDU set size in bytes, and a PSI. As an example, the PDU set information may indicate that a k-th PDU set 212 includes PDUs with sequence numbers 1 to 10 with a size of B1 bytes and a PSI value of P1, a (k+1)-th PDU set includes PDUs with sequence numbers 11 to 20 with a size of B2 bytes and a PSI value of P2, and so on. In an example, a higher PSI value may indicate a lower PDU set importance level than a lower PSI value (or vice versa). The UPF 206 may transmit the DL PDU sets 212 to the AN 204 using a GTP and may include PDU set information in respective GPT-U headers.

As further shown in FIG. 2, a QoS flow 216 can carry PDU sets of different PSI levels, for example, including low-PSI PDU set(s) 240, medium-PSI PDU set(s) 242, and high-PSI PDU set(s) 244.

The AN 204 may map the QoS flows 216 to AN resource(s) (e.g., DL radio resource(s)). That is, the AN 204 may allocate or schedule AN resource(s) for transmission of DL PDU sets 212 in the QoS flows 216 to the UE 202.

In a similar way, in the UL direction, the UE may apply QoS rules 214 to classify the incoming UL PDU sets 212 (from the client application 210) for QoS flows 216, for example, by encapsulating or marking the UL PDU sets 212 with respective QFIs. Additionally, the UE 202 may include a PDU set information generation and insertion component 220 substantially similar to the PDU set information generation and insertion component 230 at the UPF 206. The PDU set information generation and insertion component 220 may generate PDU set information for each UL PDU set 212. The UE 202 may further map the QoS flows 216 to AN resource(s) (e.g., UL radio resource(s)) for transmission to the AN 204.

In some instances, under a certain network condition (e.g., congestion), the AN 204 may be configured to perform PSI-based discard where a DL PDU set is discarded based on a PSI level of the PDU set satisfying a PSI criterion (e.g., a PSI threshold). As an example, when the higher the PSI value indicates the lower the PSI level, the gNB may discard a PDU set having a PSI value higher than the PSI threshold. The gNB may discard the PDU set further based on an expiration of a PDU discard timer associated with the PDU set.

In some instances, in the UL direction, the UE 202 may be configured with a PDU set-based discard operation for a specific DRB. When the UE 202 is configured with such a configuration, the UE may discard all packets (or PDUs) in a PDU set when one PDU belonging to this PDU set is discarded, e.g., based on a discard timer expiry. Further, under a certain network condition (e.g., congestion), the UE 202 may be configured to perform PSI-based discard where a PDU set is to be discarded based on a PSI level of the PDU set satisfying a PSI criterion.

FIG. 2 is merely an example of components of a transmission model, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

There are a variety of ways to configure a UE (e.g., the UE 150 or the UE 202) to perform PSI-based discard in a UL direction. The following will describe example options for configuring a UE to perform PSI-based discard in a UL direction.

In a first option, a DRB may be configured to have two “discarding states” corresponding to a congestion situation or condition and a non-congestion situation or condition. In other words, a DRB may switch between two discarding states, for example, state 1 and state 2. A discarding state may represent whether a UE may have different discarding handling for PDU sets (e.g., the PDU sets 212) with different PSIs on a DRB. As an example, in state 1, the UE does not discard any PDU sets regardless of their PSIs, and in state 2, the UE discards non-important PDU sets but continues to transmit all important PDU sets. As another example, in state 1, the UE is configured to use the same discard timer value for all PDU sets (including important and non-important PDU sets), and in state 2, the UE is configured with different discard timer values for important and non-important PDU sets. A discard timer value may represent a duration during which the UE may hold a PDU set in its buffer(s) before transmission. For instance, upon a PDCP entity of the UE receiving a PDU set from an application layer (e.g., the application 210), the UE may start a timer with a duration set to the specified discard timer value. If the UE fails to transmit the PDU set (e.g., due to congestion) upon an expiration of the timer, the UE may discard the PDU set.

In a second option, a UE may be configured with different discard timer values for PDU sets associated with different PSIs. For example, a PDU set with a higher PSI value may also have a longer discard timer value configured than a PDU set with a lower PSI value. That is, the UE may allow the PDU set with the lower PSI value (higher importance) to have more opportunities for transmission. However, in embodiments, the different discard timer values for PSIs may only be applicable when congestion is encountered. In embodiments, the approach of using different discard timer values for different PSIs may not be effective when congestion status changes dynamically, as there will be time delays from the congestion indication to the actual packet discarding.

In a third option, a UE may be configured to perform PSI threshold-based discarding (regardless of expiry of a discard timer). In this option, the UE may be configured with a PSI threshold and may be configured to discard lower priority PDU sets based on the PSI threshold when congestion is encountered. For instance, the UE may discard PDU sets with a higher PSI value than the PSI threshold (assuming a higher PSI value indicates a lower PSI level). The discarding may be performed, without regard to an associated discard timer running status, to enable early discard of less important PDU sets in a congestion situation. For instance, upon receiving a congestion indication from a gNB (e.g., the network node 120 or the AN 204), the UE can immediately discard packets with low importance in its buffer, and thus may be more effective than the second option when dynamic congestion is present in the network. The UE can keep discarding low importance packets regardless of expiry of a discard timer until the end of congestion.

In a fourth option, a gNB (e.g., the network node 120 or AN 204) may control PDU set discard at a UE. In a first sub-option, the gNB may temporarily adjust a PDCP discard timer length of low-PSI PDU sets, for example, by setting the PDCP discard timer length to 0 (e.g., 0 milliseconds) when congestion happens. Consequently, low-PSI PDU sets may be discarded immediately at the UE when congestion happens. In a second sub-option, the gNB may indicate the UE to discard the PDU sets with low PSI. When the value of a PDCP discard timer is set to 0 for the first sub-option, the outcome of the first and second sub-options may be the same, but the first sub-option may allow the UE to reuse the existing 3GPP procedures (e.g., current 3GPP PDCP discard mechanisms) to a large extent. On the other hand, the second sub-option may introduce a new indictor (for the UE to discard low-PSI PDUs) and new UE behavior to achieve the same outcome as the first sub-option. Furthermore, in the case of the first sub-option, the gNB may have more flexibility as the gNB does not have to set the discard timer to 0 (for immediate discard), but can use another value, for example, a value shorter than a previous PDCP discard timer value. This way, it may allow at least some low-PSI PDU sets to be transmitted when there is a scheduling occasion that can be used for transmission. Hence, the first sub-option may be desirable due to its simplicity and flexibility.

As discussed above, having a UE continue with PSI-based discard, when a network has changed conditions (e.g., less congestion) and can support the UE transmissions, may be undesirable as the PSI-based discard can unnecessarily downgrade a user's QoE.

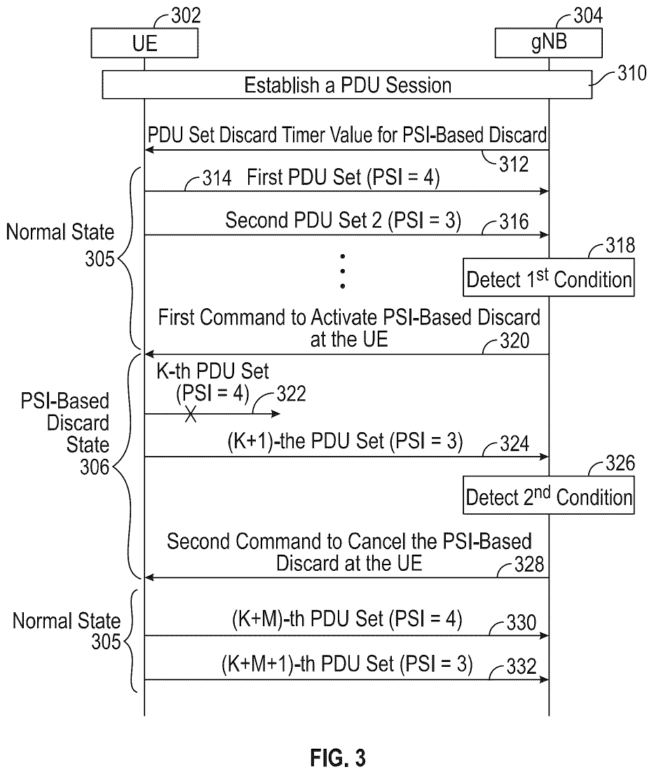

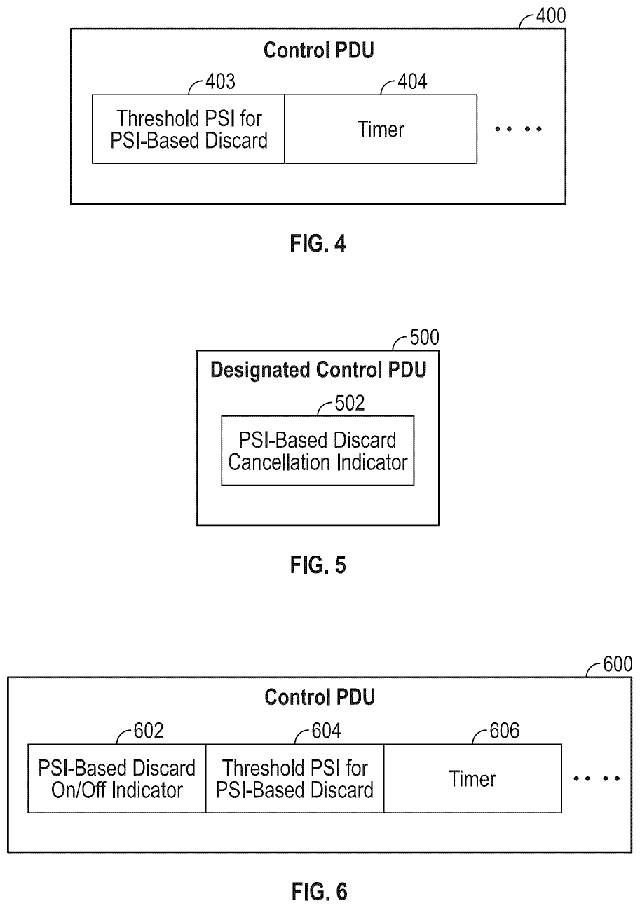

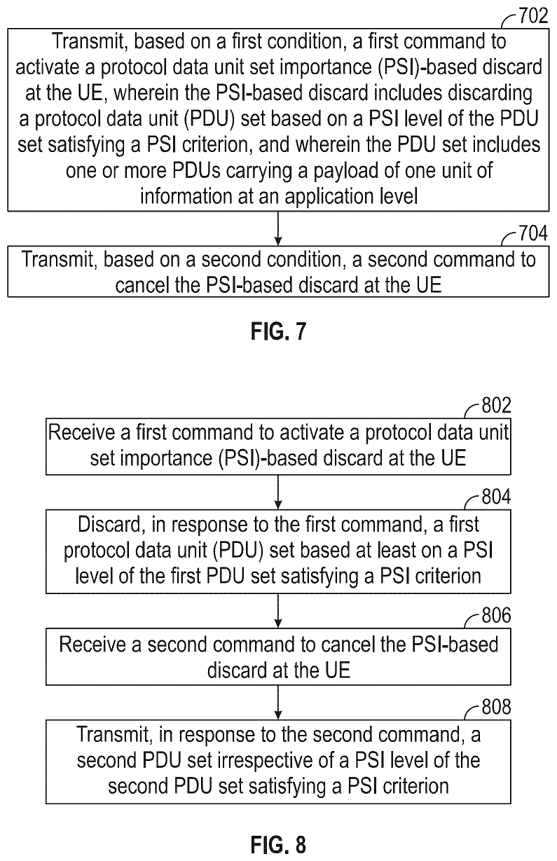

The following will describe example operations for configuring PSI-based discard configurations including dynamic activation and cancellation of PSI-based discard at a UE. FIG. 3 shows example signals and operations of a network system for packet transmission with PSI-based discard configuration. FIGS. 4-6 show various example packet formats for indicating a PSI-based discard cancellation to a UE. FIG. 7 shows example operations of a network apparatus, and FIG. 8 shows example operations of a UE.

FIG. 3 is a diagram of an example embodiment of operations for packet transmission with PSI-based discard configurations, according to one illustrated aspect of the present disclosure. It will be understood that a described signal may have associated operations and a described operation may have associated signals. Accordingly, a described signal may also involve an operation and a described operation may also involve a signal. Additionally, FIG. 3 will describe signals between and operations performed by various network components, such as those shown at the top of FIG. 3. Specifically, the components include a UE 302 and a gNB 304. In an aspect, the UE 302 may correspond to the UE 150 of FIG. 1 and the gNB 304 may correspond to the network node 120 of FIG. 1. In an aspect, the UE 302 may correspond to the UE 202 of FIG. 2 and the gNB 304 may correspond to the AN 204 of FIG. 2. The network components are illustrative, and it is contemplated that other components may be involved in the signals or may perform the operations. In some examples, each of the UE 302 and the gNB 304 may implement the operations using an apparatus with components as shown in FIG. 9. One or more of the following operations may be implemented in connection with the operations of the present disclosure, such as the examples discussed above with reference to FIG. 2.

At operation 310, the UE 302 and the gNB 304 establish a PDU session (e.g., the PDU session 218) for communication. For instance, the gNB 304 may serve the UE 302 an application or a service (e.g., an XR service) over the PDU session.

At operation 312, the gNB 304 transmits, and the UE 302 receives a PDU set discard timer value for PSI-based discard. The PDU set discard timer value may indicate a duration. As will be discussed below, for PSI-based discard, the UE 302 (e.g., a PDCP entity of the UE 302) may set a timer according to the PDU set discard timer value upon receiving a PDU set satisfying a PSI criterion and may discard the PDU set upon an expiration of the timer. In some instances, the gNB 304 may transmit the PDU set discard timer value for PSI-based discard via RRC signaling.

The UE 302 may receive a plurality of PDU sets from an application. The application may generate PDU set information for each PDU set and transmit the PDU set information to the UE 302 along with the plurality of PDU sets. The UE 302 may read the PDU set information, map the PDU sets to QoS flows of the PDU session, and transmit the PDU sets over the QoS flows as discussed above with reference to FIG. 2. The PDU set information may include, for example, but not limited to, a PDU set sequence number, an indication of an end PDU of the respective PDU set, PDU sequence numbers within a PDU set, a PDU set size in bytes, and a PSI for a respective PDU set.

At a high level, the UE 302 may switch between a normal state 305 and a PSI-based discard state 306 based on controls from the gNB 304. The UE 302 may begin with operating in the normal state 305. The following operations and signals are discussed based on the example where a lower PSI value indicates a higher PSI level. However, in other examples, a lower PSI value can indicate a lower PSI level.

During the normal state 305, the UE 302 may transmit a PDU set irrespective of a PSI level of the PDU set. For example, at operation 314, the UE 302 transmits, and the gNB 304 receives a first PDU set with a PSI value of 4. At operation 316, the UE 302 transmits, and the gNB 304 receives a second PDU set with a PSI value of 3.

At operation 318, the gNB 304 detects a first condition. In an example, the first condition may be traffic congestion. In general, the gNB 304 may perform the detection based on various network, scheduling, and/or traffic characteristics, such as resource availability, a packet error rate, a bit error rate, a retransmission rate, etc. The gNB 304 may determine to activate PSI-based discard at the UE 302 based on the detected first condition.

At operation 320, the gNB 304 transmits under the first condition, and the UE 302 receives a first command to activate PSI-based discard at the UE. The gNB 304 may transmit the first command in a variety of ways. In aspects, the gNB 304 may transmit a control PDU including an indication of a PSI criterion. The PSI criterion may be a threshold PSI to control which PDU sets the UE 302 may apply the PDU set discard timer value (received at operation 312) for the PSI-based discard. The control PDU can optionally include a time value indicating a duration during which the UE 302 may apply the PSI-based discard to its transmission. Upon receiving the first command (the activation command), the UE 302 may transition from the normal state 305 to the PSI-based discard state 306.

During the PSI-based discard state 306, the UE 302 may apply the PDU set discard timer value (received at operation 312) to a PDU set if the PSI level of the PDU set satisfies the PSI criterion. In the illustrated example of FIG. 3, the PSI criterion is satisfied if a PDU set has a PSI value higher than the threshold PSI. In other words, the UE 302 may apply the PDU set discard timer value to a PDU set if the PSI value of the PDU set is higher than the threshold PSI.

As an example, the PSI threshold in the first command at operation 320 is set to 3. As shown, a K-th PDU set with a PSI value of 4 is to be transmitted as operation 322. For instance, the UE 302 may queue or store the K-th PDU set at its buffer, waiting for a scheduling occasion to transmit the K-th PDU set. The UE 302 may compare the PSI value of the K-th PDU set to the threshold PSI. Because the PSI value of 4 is higher (or greater) than the threshold PSI of 3 (meaning that the K-th PDU set fails the PSI criterion), the UE 302 may apply a timer configured with the PDU set discard timer value to the K-th PDU set. For instance, a PDCP entity at the UE 302 may start a timer configured with a duration set to the PDU set discard timer value upon receiving the k-th PDU set from the application. If the K-th PDU set is not submitted to lower layers (e.g., RLC, MAC, and/or PHY of the UE 302) before the timer expires, the UE 302 may discard the K-th PDU set upon an expiration of the timer, for example, as shown by the cross symbol (“X”).

At operation 324, the UE 302 transmits, and the gNB 304 receives a (K+1)-th PDU set with a PSI value of 3. The UE 302 may compare the PSI value of the (K+1)-th PDU set to the threshold PSI. Because the PSI value of 3 is not higher than the threshold PSI (meaning that the (K+1)-th PDU set satisfies the PSI criterion), the UE 302 may not apply the PDU set discard timer value to the (K+1)-th PDU set for the PSI-based discard. Thus, the UE 302 may queue the (K+1)-th PDU set in a buffer and may transmit the (K+1)-th PDU set when a radio resource is available for the transmission. In other examples, the PSI criterion is satisfied if a PDU set has a PSI value higher than or equal to the threshold PSI. In such examples, the UE 302 may also apply the PDU set discard timer value to the (K+1)-th PDU set based on the (K+1)-th PDU set having a PSI value of 3, which is equal to the threshold PSI of 3. At operation 326, the gNB 304 detects a second condition (e.g., a traffic non-congestion condition). The gNB 304 may determine to cancel the PSI-based discard at the UE 302 based on the detected second condition.

At operation 328, the gNB 304 transmits based on the second condition, and the UE 302 receives a second command to cancel the PSI-based discard at the UE. As will be discussed more below with reference to FIGS. 4-6, the gNB 304 may transmit the second command in a variety of ways. Upon receiving the second command (the cancellation command), the UE 302 may transition from the PSI-based discard state 306 back to the normal state 305.

After returning to the normal state 305, the UE 302 may transmit a PDU set irrespective of whether the PSI level of the PDU set satisfies the PSI criterion. For example, at operation 320 the UE 302 transmits, and the gNB 304 receives a (K+M)-th PDU set with a PSI value of 4. Because of the PSI-based discard cancellation in the second command, the UE 302 may transmit the (K+M)-th PDU set irrespective of the (K+M)-th PDU set having a PSI value satisfying the PSI criterion (e.g., threshold PSI of 3). In other examples, the UE 302 may be configured with a PDCP discard timer in addition to the PDU set discard timer. Thus, while the UE 302 does not discard the (K+M)-th PDU set based on the PSI value of the (K+M)-th PDU set, the UE 302 may discard the (K+M)-th PDU set based on an expiry of the PDCP discard timer.

At operation 332, the UE 302 transmits, and the gNB 304 receives a (K+M+1)-th PDU set with a PSI value of 3.

In aspects, the gNB 304 may transmit the first command (the PSI-based discard activation) at operation 320 and/or the second command (the PSI-based discard cancellation) at operation 328 via PDCP signaling. In aspects, the gNB 304 may transmit the first command (the PSI-based discard activation) at operation 320 and/or the second command (the PSI-based discard cancellation) at operation 328 via UE-specific or dedicated signaling.

In aspects, the PDU set discard timer is separate from and independent of a PDCP discard timer, and the operations of FIG. 3 can be performed in conjunction with 3GPP PDCP discard procedures.

The signals and operations of FIG. 3 are merely illustrative, and variations are contemplated to be within the scope of the present disclosure. In embodiments, the signals and operations may include others not illustrated in FIG. 3. In embodiments, the signals and operations may not include every signal and operation illustrated in FIG. 3. In embodiments, the signals and operations may be implemented in a different order than that illustrated in FIG. 3. Such and other embodiments are contemplated to be within the scope of the present disclosure.

FIGS. 4-6 illustrate various packet formats for a gNB (e.g., the network node 120 of FIG. 1, the AN 204 of FIG. 2, and/or the gNB 304 of FIG. 3) to cancel a PSI-based discard at the UE. For instance, the gNB 304 of FIG. 3 may use any one of the packet formats shown in FIGS. 4-6 to indicate the second command (PSI-based cancellation command) at signal 328.

FIG. 4 is an example packet including an indication of a PSI-based discard cancellation, according to one illustrated aspect of the present disclosure. As shown in FIG. 4, a control PDU 400 may include a packet field 403 and a packet field 404. The packet field 403 may indicate a threshold PSI for PSI-based discard at a UE (e.g., the UE 150, 202, and/or 302). In aspects, the packet field 403 (threshold PSI) may be set to a maximum allowable (highest) PSI value to indicate a PSI-based discard cancellation (the second command at signal 328) at the UE.

In aspects, the control PDU 400 may be a control PDU for activating a PSI-based discard at a UE, where the threshold PSI (in the packet field 403) may be a PSI criterion for the UE to discard a PDU set and a duration indicated in the packet field 404 may be a duration during which the PSI-based discard is to be activated. As discussed above, when a higher PSI value indicates a lower PSI level, there may not be any PDU set with a PSI value higher than the maximum allowable PSI value. As an example, the packet field 403 may be 4-bits long with 0 being highest priority and 15 lowest. Thus, setting the packet field 403 to 15 may cause the UE not to discard any PDU set based on a respective PSI, and effectively cancelling the PSI-based discard. Stated differently, the PSI-based discard cancellation (second command) can be indicated by reusing a threshold PSI packet field 403 in a control PDU for PSI-based discard activation. Reusing the threshold PSI packet field 403 can free a codepoint in the control PDU, and thus can allow for more efficient use of radio resources. Further, when the control PDU 400 is used for a PSI-based discard cancellation, the packet field 404 may be reused to indicate a duration during which the PSI-based discard is to be cancelled.

The packet fields of FIG. 4 are merely illustrative, and variations are contemplated to be within the scope of the present disclosure. In embodiments, the control PDU 400 may include other fields not illustrated in FIG. 4. In embodiments, the control PDU 400 may not include every packet field illustrated in FIG. 4. In embodiments, the packet fields may be arranged in a different order than that illustrated in FIG. 4. Such and other embodiments are contemplated to be within the scope of the present disclosure.

FIG. 5 is an example packet including an indication of a PSI-based discard cancellation, according to one illustrated aspect of the present disclosure. As shown in FIG. 5, a designated control PDU 500 may include a packet field 502. The designated control PDU 500 may be specific for PSI-based discard cancellation indication. The packet field 502 may be a one-bit flag indicating a cancellation (or revocation) of a PSI-based discard (the second command at signal 328) at the UE.

The packet field of FIG. 5 is merely illustrative, and variations are contemplated to be within the scope of the present disclosure. In embodiments, the designated control PDU 500 may include other fields not illustrated in FIG. 5. Such and other embodiments are contemplated to be within the scope of the present disclosure.

FIG. 6 is an example packet including an indication of a PSI-based discard cancellation, according to one illustrated aspect of the present disclosure. As shown in FIG. 6, a control PDU 600 may include a packet field 602, a packet field 604, and a packet field 606. The control PDU 600 may be used by a gNB to activate or deactivate a PSI-based discard at a UE. The packet field 602 may be a one-bit flag (a reserved flag) indicating whether PSI-based discard is to be turned on (e.g., for activation) or off (e.g., for cancellation) at the UE. For example, a flag value of 1 may indicate an activation (an on-value) and a flag value of 0 may indicate a cancellation (an off-value), or vice versa. The packet field 604 may indicate a threshold PSI for a PSI-based discard at the UE. If the packet field 602 indicates an activation, the packet field 606 may indicate a duration during which a PSI-based discard is to be activated. If, however, the packet field 602 indicates a cancellation, the packet field 606 may indicate a duration during which a PSI-based discard is to be cancelled.

The packet fields of FIG. 6 are merely illustrative, and variations are contemplated to be within the scope of the present disclosure. In embodiments, the control PDU 600 may include other fields not illustrated in FIG. 6. In embodiments, the control PDU 600 may not include every packet field illustrated in FIG. 6. In embodiments, the packet fields may be arranged in a different order than that illustrated in FIG. 6. Such and other embodiments are contemplated to be within the scope of the present disclosure.

In aspects, the gNB 304 may transmit the control PDU 400 of FIG. 4, the designated control PDU 500 of FIG. 5, and/or the control PDU 600 of FIG. 6 via PDCP signaling (as a PDCP control PDU). In general, the control PDUs 400, 500, and/or 600 can be transmitted via any suitable signaling, such as medium access control-control element (MAC-CE), layer 1 (L1), and/or RRC signaling.

In aspects, the cancellation of a PSI-based discard at the UE 302 can be one-shot, an explicit indication, timer-based, and/or buffer size-based. For one-shot cancellation, the gNB 304 may indicate to the UE 302 to cancel a PSI-based discard without specifying a duration during which the PSI-based discard is to be cancelled. For explicit indication, the gNB 304 may use any one of the control PDUs 400, 500, or 600 to indicate the PSI-based discard cancellation. For time-based cancellation, the gNB 304 may configure the UE 302 with a timer, where an expiration of the timer may trigger the PSI-based discard cancellation. For buffer-based cancellation, the gNB 304 may configure the UE 302 with a buffer threshold to trigger PSI-based discard cancellation. For instance, if a transmission buffer at the UE 302 is below a certain threshold (e.g., lower than X % full), the UE 302 may stop applying PSI-based discard to PDU sets in the transmission buffer.

FIG. 7 is a flow diagram of example operations of a network apparatus that controls PSI-based discard for UL transmission at a UE, according to one illustrated aspect of the present disclosure. In an aspect, the network apparatus may correspond to the network node 120 discussed above with reference to FIG. 1, the AN 204 discussed above with reference to FIG. 2, and/or the gNB 304 discussed above with reference to FIG. 3. In some examples, the network apparatus may implement the operations using an apparatus with components as shown in FIG. 9. The operations of FIG. 7 may include similar mechanisms as discussed above with reference to FIGS. 2-6. As illustrated, FIG. 7 includes a number of enumerated steps, but aspects of the operations in FIG. 7 may include additional steps before, after, and in between the enumerated steps. In aspects, one or more of the enumerated steps may be omitted or performed in a different order.

At block 702, the network apparatus transmits, to a UE (e.g., the UEs 150, 202, 302) based on a first condition, a first command to activate a PSI-based discard at the UE. In some instances, the first condition may be a traffic congestion condition detected by the network apparatus (e.g., based on resource availability, a packet error rate, a bit error rate, a retransmission rate, etc.). The PSI-based discard includes discarding a PDU set (e.g., the PDU sets 212) based on a PSI level of the PDU set satisfying a PSI criterion. The PDU set includes one or more PDUs carrying a payload of one unit of information at an application level. In some instances, the payload in the PDU set for the PSI-based discard is associated with an XR application.

At block 704, the network apparatus transmits, to the UE based on a second condition, a second command to cancel the PSI-based discard at the UE. In some instances, the second condition may be a traffic non-congestion condition detected by the network apparatus (e.g., based on resource availability, a packet error rate, a bit error rate, a retransmission rate, etc.). In general, the occurrence of the second condition may be due to the first condition is subdued or recovered.

In aspects, as part of transmitting the second command to cancel PSI-based discard at block 704, the network apparatus transmits, to the UE, a control PDU including a flag value (e.g., a one-bit flag) indicating the second command, for example, as discussed above with reference to FIGS. 5-6. In aspects, the control PDU is a designated control PDU specific for PSI-based discard cancellation, for example, as discussed above with reference to FIG. 5. In aspects, the control PDU further includes a timer value indicating a duration during which the PSI-based discard is to be cancelled, for example, as discussed above with reference to FIG. 6. In aspects, as part of transmitting the second command to cancel PSI-based discard at block 704, the network apparatus transmits, to the UE, a control PDU including a threshold PSI value set to a highest allowable PSI value to indicate the second command to cancel of the PSI-based discard, for example, as discussed above with reference to FIG. 4.

In aspects, as part of transmitting the second command to cancel PSI-based discard at block 704, the network apparatus transmits, to the UE, a PDCP control PDU including the second command.

In aspects, the first command at block 702 includes an indication of the PSI criterion including a threshold PSI and an indication of a duration during which the PSI-based discard is to be activated. In aspects, the second command at block 704 overrides the duration indicated in the first command.

FIG. 8 is a flow diagram of example operations of a UE that performs UL transmissions with PSI-based discard controlled by a network, according to one illustrated aspect of the present disclosure. In an aspect, the UE may correspond to the UE 150 discussed above with reference to FIG. 1, the UE 202 discussed above with reference to FIG. 2, and/or the UE 302 discussed above with reference to FIG. 3. In some examples, the UE may implement the operations using an apparatus with components as shown in FIG. 9. The operations of FIG. 8 may include similar mechanisms as discussed above with reference to FIGS. 2-6. As illustrated, FIG. 8 includes a number of enumerated steps, but aspects of the operations in FIG. 8 may include additional steps before, after, and in between the enumerated steps. In aspects, one or more of the enumerated steps may be omitted or performed in a different order.

At block 802, the UE receives a first command to activate a PSI-based discard at the UE.

At block 804, the UE discards, in response to the first command, a first PDU set (e.g., the PDU sets 212) based at least on a PSI level of the first PDU set satisfying a PSI criterion, where the first PDU set includes one or more PDUs carrying a payload of one unit of information at an application level.

At block 806, the UE receives a second command to cancel the PSI-based discard at the UE.

At block 808, the UE transmits, in response to the second command, a second PDU set (e.g., the PDU sets 212) irrespective of a PSI level of the second PDU set satisfying the PSI criterion. The transmitting of the second PDU set may refer to a PDCP entity of the UE submitting the second PDU set to a lower layer (e.g., an RLC entity of the UE).

In aspects, the payload in the first PDU set discarded at block 704 and/or the second PDU set discarded at block 708 are associated with an XR application.

In aspects, as part of receiving the second command to cancel the PSI-based discard at block 706, the UE receives a control PDU including a flag value (e.g., one-bit flag) indicating the second command, for example, as discussed above with reference to FIGS. 5-6. In aspects, the control PDU is a designated control PDU specific for PSI-based discard cancellation, for example, as discussed above with reference to FIG. 5. In aspects, the control PDU further includes a timer value indicating a duration during which the PSI-based discard is to be cancelled, for example, as discussed above with reference to FIG. 6.

In aspects, as part of receiving the second command to cancel the PSI-based discard at block 706, the UE receives a control PDU including a threshold PSI value set to a highest allowable PSI value to indicate the second command to cancel of the PSI-based discard, as discussed above with reference to FIG. 4.

In aspects, as part of receiving the second command to cancel the PSI-based discard at 806, the UE receives a PDCP control PDU including the second command.

In aspects, as part of receiving the first command to cancel the PSI-based discard at block 806, the UE receives an indication of the PSI criterion including a threshold PSI and an indication of a duration during which the PSI-based discard is to be activated. In aspects, the UE further disregard the duration indicated in the first command upon receiving the second command.

Referring now to FIG. 9, there is shown a block diagram of example components of a UE or a network apparatus. The apparatus includes an electronic storage 910, a processor 920, a memory 950, and a network interface 940. The various components may be communicatively coupled with each other. The processor 920 may be and may include any type of processor, such as a single-core central processing unit (CPU), a multi-core CPU, a microprocessor, a digital signal processor (DSP), a System-on-Chip (SoC), or any other type of processor. The memory 950 may be a volatile type of memory, e.g., RAM, or a non-volatile type of memory, e.g., NAND flash memory. The memory 950 includes processor-readable instructions that are executable by the processor 920 to cause the apparatus to perform various operations, including those mentioned herein, such as the operations of FIGS. 3-9.

The electronic storage 910 may be and include any type of electronic storage used for storing data, such as hard disk drive, solid state drive, and/or optical disc, among other types of electronic storage. The electronic storage 910 stores processor-readable instructions for causing the apparatus to perform its operations and stores data associated with such operations, such as storing data relating to 5G NR standards, among other data. The network interface 940 may implement wireless networking technologies such as 5G NR and/or other wireless networking technologies.

The components shown in FIG. 9 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1.1. A method comprising:
transmitting, by a network apparatus to a user equipment (UE) based on a first condition, a first command to activate a data unit set importance (PSI)-based discard at the UE, wherein the PSI-based discard includes discarding a protocol data unit (PDU) set based on a PSI level of the PDU set satisfying a PSI criterion, and wherein the PDU set includes one or more PDUs carrying a payload of one unit of information at an application level; and
transmitting, by the network apparatus to the UE based on a second condition, a second command to cancel the PSI-based discard at the UE.

Example 1.2. The method of Example 1.1, wherein the payload in the PDU set for the PSI-based discard is associated with an extended reality application.

Example 1.3. The method of Example 1.1 or Example 1.2, wherein the transmitting the second command to cancel PSI-based discard comprises:
transmitting, by the network apparatus to the UE, a control PDU including a flag value indicating the second command.

Example 1.4. The method of Example 1.3, wherein the control PDU is a designated control PDU specific for PSI-based discard cancellation.

Example 1.5. The method of Example 1.3, wherein the control PDU further includes a timer value indicating a duration during which the PSI-based discard is to be cancelled.

Example 1.6. The method of Example 1.1 or Example 1.2, wherein the transmitting the second command to cancel PSI-based discard comprises:
transmitting, by the network apparatus to the UE, a control PDU including a threshold PSI value set to a highest allowable PSI value to indicate the second command to cancel the PSI-based discard.

Example 1.7. The method of any one of Examples 1.1-1.6, wherein the transmitting the second command to cancel PSI-based discard comprises:
transmitting, by the network apparatus to the UE, a packet data convergence protocol (PDCP) control PDU including the second command.

Example 1.8. The method of any one of Examples 1.1-1.7, wherein the first command includes an indication of the PSI criterion including a threshold PSI and an indication of a duration during which the PSI-based discard is to be activated.

Example 1.9. The method of Example 1.8, wherein the second command further overrides the duration during which the PSI-based discard is activated.

Example 2.1. A method comprising:
receiving, by a user equipment (UE), a first command to activate a protocol data unit set importance (PSI)-based discard at the UE;
discarding, by the UE in response to the first command, a first protocol data unit (PDU) set based at least on a PSI level of the first PDU set satisfying a PSI criterion, wherein the first PDU set includes one or more PDUs carrying a payload of one unit of information at an application level;
receiving, by the UE, a second command to cancel the PSI-based discard at the UE; and
transmitting, by the UE in response to the second command, a second PDU set irrespective of a PSI level of the second PDU set satisfy the PSI criterion.

Example 2.2. The method of Example 2.1, wherein the payload in the discarded first PDU set is associated with an extended reality application.

Example 2.3. The method of Example 2.1 or Example 2.2, wherein the receiving the second command to cancel PSI-based discard comprises:
receiving, by the UE, a control PDU including a flag value indicating the second command.

Example 2.4. The method of Example 2.3, wherein the control PDU is a designated control PDU specific for PSI-based discard cancellation.

Example 2.5. The method of Example 2.3, wherein the control PDU further includes a timer value indicating a duration during which the PSI-based discard is to be cancelled.

Example 2.6. The method of Example 2.1 or Example 2.2, wherein the receiving the second command to cancel PSI-based discard comprises:
receiving, by the UE, a control PDU including a threshold PSI value set to a highest allowable PSI value to indicate the second command to cancel of the PSI-based discard.

Example 2.7. The method of any one of Examples 2.1-2.6, wherein the receiving the second command to cancel PSI-based discard comprises:
receiving, by the UE, a packet data convergence protocol (PDCP) control PDU including the second command.

Example 2.8. The method of any one of Examples 2.1-2.6, wherein the receiving the second command to cancel PSI-based discard comprises:
receiving, by the UE, an indication of the PSI criterion including a threshold PSI and an indication of a duration during which the PSI-based discard is to be activated.

Example 3.1. An apparatus comprising:
at least one processor; and
at least one memory storing instructions which, when executed by the processor, cause the apparatus at least to perform:
transmitting, by a network apparatus to a user equipment (UE) based on a first condition, a first command to activate a protocol data unit set importance (PSI)-based discard at the UE, wherein the PSI-based discard includes discarding a protocol data unit (PDU) set based on a PSI level of the PDU set satisfying a PSI criterion, and wherein the PDU set includes one or more PDUs carrying a payload of one unit of information at an application level; and
transmitting, by the network apparatus to the UE based on a second condition, a second command to cancel the PSI-based discard at the UE.

Example 3.2. The apparatus of Example 3.1, wherein the payload in the PDU set for the PSI-based discard is associated with an extended reality application.

Example 3.3. The apparatus of Example 3.1 or Example 3.2, wherein the transmitting the second command to cancel PSI-based discard comprises:
transmitting, by the network apparatus to the UE, a control PDU including a flag value indicating the second command.

Example 3.4. The apparatus of Example 3.3, wherein the control PDU is a designated control PDU specific for PSI-based discard cancellation.

Example 3.5. The apparatus of Example 3.3, wherein the control PDU further includes a timer value indicating a duration during which the PSI-based discard is to be cancelled.

Example 3.6. The apparatus of Example 3.1 or Example 3.2, wherein the transmitting the second command to cancel PSI-based discard comprises:
transmitting, by the network apparatus to the UE, a control PDU including a threshold PSI value set to a highest allowable PSI value to indicate the second command to cancel the PSI-based discard.

Example 3.7. The apparatus of any one of Examples 3.1-3.6, wherein the transmitting the second command to cancel PSI-based discard comprises:
transmitting, by the network apparatus to the UE, a protocol data convergence protocol (PDCP) control PDU including the second command.

Example 3.8. The apparatus of any one of Examples 3.1-3.7, wherein the first command includes an indication of the PSI criterion including a threshold PSI and an indication of a duration during which the PSI-based discard is to be activated.

Example 3.9. The apparatus of Example 3.8, wherein the second command further overrides the duration during which the PSI-based discard is activated.

Example 4.1. An apparatus comprising:
at least one processor; and
at least one memory storing instructions which, when executed by the processor, cause the apparatus at least to perform:
receiving, by a user equipment (UE), a first command to activate a protocol data unit set importance (PSI)-based discard at the UE;
discarding, by the UE in response to the first command, a first protocol data unit (PDU) set based at least on a PSI level of the first PDU set satisfying a PSI criterion, wherein the first PDU set includes one or more PDUs carrying a payload of one unit of information at an application level;
receiving, by the UE, a second command to cancel the PSI-based discard at the UE; and
transmitting, by the UE in response to the second command, a second PDU set irrespective of a PSI level of the second PDU set satisfy the PSI criterion.

Example 4.2. The apparatus of Example 4.1, wherein the payload in the discarded first PDU set is associated with an extended reality application.

Example 4.3. The apparatus of Example 4.1 or Example 4.2, wherein the receiving the second command to cancel PSI-based discard comprises:
receiving, by the UE, a control PDU including a flag value indicating the second command.

Example 4.4. The apparatus of Example 4.3, wherein the control PDU is a designated control PDU specific for PSI-based discard cancellation.

Example 4.5. The apparatus of Example 4.3, wherein the control PDU further includes a timer value indicating a duration during which the PSI-based discard is to be cancelled.

Example 4.6. The apparatus of Example 4.1 or Example 4.2, wherein the receiving the second command to cancel PSI-based discard comprises:
receiving, by the UE, a control PDU including a threshold PSI value set to a highest allowable PSI value to indicate the second command to cancel of the PSI-based discard.

Example 4.7. The apparatus of any one of Examples 4.1-4.6, wherein the receiving the second command to cancel PSI-based discard comprises:
receiving, by the UE, a packet data convergence protocol (PDCP) control PDU including the second command.

Example 4.8. The apparatus of any one of Examples 4.1-4.6, wherein the receiving the second command to cancel PSI-based discard comprises:
receiving, by the UE, an indication of the PSI criterion including a threshold PSI and an indication of a duration during which the PSI-based discard is to be activated.

Example 5.1. An apparatus comprising:
means for transmitting, by a network apparatus to a user equipment (UE) based on a first condition, a first command to activate a protocol data unit set importance (PSI)-based discard at the UE, wherein the PSI-based discard includes discarding a protocol data unit (PDU) set based on a PSI level of the PDU set satisfying a PSI criterion, and wherein the PDU set includes one or more PDUs carrying a payload of one unit of information at an application level; and
means for transmitting, by the network apparatus to the UE based on a second condition, a second command to cancel the PSI-based discard at the UE.

Example 5.2. The apparatus of Example 5.1, wherein the payload in the PDU set for the PSI-based discard is associated with an extended reality application.

Example 5.3. The apparatus of Example 5.1 or Example 5.2, wherein the means for transmitting the second command to cancel PSI-based discard comprises:
means for transmitting, by the network apparatus to the UE, a control PDU including a flag value indicating the second command.

Example 5.4. The apparatus of Example 5.3, wherein the control PDU is a designated control PDU specific for PSI-based discard cancellation.

Example 5.5. The apparatus of Example 5.3, wherein the control PDU further includes a timer value indicating a duration during which the PSI-based discard is to be cancelled.

Example 5.6. The apparatus of Example 5.1 or Example 5.2, wherein the means for transmitting the second command to cancel PSI-based discard comprises:
means for transmitting, by the network apparatus to the UE, a control PDU including a threshold PSI value set to a highest allowable PSI value to indicate the second command to cancel the PSI-based discard.

Example 5.7. The apparatus of any one of Examples 5.1-5.6, wherein the means for transmitting the second command to cancel PSI-based discard comprises:
means for transmitting, by the network apparatus to the UE, a packet data convergence protocol (PDCP) control PDU including the second command.

Example 5.8. The apparatus of any one of Examples 5.1-5.7, wherein the first command includes an indication of the PSI criterion including a threshold PSI and an indication of a duration during which the PSI-based discard is to be activated.

Example 5.9. The apparatus of Example 5.8, wherein the second command further overrides the duration during which the PSI-based discard is activated.

Example 6.1. An apparatus comprising:
means for receiving, by a user equipment (UE), a first command to activate a protocol data unit set importance (PSI)-based discard at the UE;
means for discarding, by the UE in response to the first command, a first protocol data unit (PDU) set based at least on a PSI level of the first PDU set satisfying a PSI criterion, wherein the first PDU set includes one or more PDUs carrying a payload of one unit of information at an application level;
means for receiving, by the UE, a second command to cancel the PSI-based discard at the UE; and
means for transmitting, by the UE in response to the second command, a second PDU set irrespective of a PSI level of the second PDU set satisfy the PSI criterion.

Example 6.2. The apparatus of Example 6.1, wherein the payload in the discarded first PDU set is associated with an extended reality application.

Example 6.3. The apparatus of Example 6.1 or Example 6.2, wherein the means for receiving the second command to cancel PSI-based discard comprises:
means for receiving, by the UE, a control PDU including a flag value indicating the second command.

Example 6.4. The apparatus of Example 6.3, wherein the control PDU is a designated control PDU specific for PSI-based discard cancellation.

Example 6.5. The apparatus of Example 6.3, wherein the control PDU further includes a timer value indicating a duration during which the PSI-based discard is to be cancelled.

Example 6.6. The apparatus of Example 6.1 or Example 6.2, wherein the means for receiving the second command to cancel PSI-based discard comprises:
means for receiving, by the UE, a control PDU including a threshold PSI value set to a highest allowable PSI value to indicate the second command to cancel of the PSI-based discard.

Example 6.7. The apparatus of any one of Examples 6.1-6.6, wherein the means for receiving the second command to cancel PSI-based discard comprises:
means for receiving, by the UE, a packet data convergence protocol (PDCP) control PDU including the second command.

Example 6.8. The apparatus of any one of Examples 6.1-6.6, wherein the means for receiving the second command to cancel PSI-based discard comprises:
means for receiving, by the UE, an indication of the PSI criterion including a threshold PSI and an indication of a duration during which the PSI-based discard is to be activated.

Example 7. A non-transitory processor-readable medium including program code, which when executed by one or more processors, causes the one or more processors at least to perform the method of any one of Examples 1.1-1.9.

Example 8. A non-transitory processor-readable medium including program code, which when executed by one or more processors, causes the one or more processors at least to perform the method of any one of Examples 2.1-2.8.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A network apparatus comprising:
at least one processor; and
at least one memory storing instructions which, when executed by the processor, cause the apparatus at least to perform the following:
transmitting, to a user equipment (UE) based on a first condition, a first command to activate a protocol data unit set importance (PSI)-based discard at the UE, wherein the PSI-based discard includes discarding a protocol data unit (PDU) set based on a PSI level of the PDU set satisfying a PSI criterion, and wherein the PDU set includes one or more PDUs carrying a payload of one unit of information at an application level; and
transmitting, to the UE based on a second condition, a second command to cancel the PSI-based discard at the UE.

2. The network apparatus of claim 1, wherein the payload in the PDU set for the PSI-based discard is associated with an extended reality application.

3. The network apparatus of claim 1, configured to transmit, to the UE, a control PDU including a flag value indicating the second command.

4. The network apparatus of claim 3, wherein the control PDU is a designated control PDU specific for PSI-based discard cancellation.

5. The network apparatus of claim 3, wherein the control PDU further includes a timer value indicating a duration during which the PSI-based discard is to be cancelled.

6. The network apparatus of claim 1, configured to transmit, to the UE, a control PDU including a threshold PSI value set to a highest allowable PSI value to indicate the second command to cancel the PSI-based discard.

7. The network apparatus of claim 1, configured to transmit, to the UE, a packet data convergence protocol (PDCP) control PDU including the second command.

8. The network apparatus of claim 1, wherein the first command includes an indication of the PSI criterion including a threshold PSI and an indication of a duration during which the PSI-based discard is to be activated.

9. The network apparatus of claim 8, wherein the second command further overrides the duration during which the PSI-based discard is activated.

10. An apparatus for user equipment (UE), comprising:
at least one processor; and
at least one memory storing instructions which, when executed by the processor, cause the apparatus at least to perform the following:
receiving a first command to activate a protocol data unit set importance (PSI)-based discard at the UE;
discarding, in response to the first command, a first protocol data unit (PDU) set based at least on a PSI level of the first PDU set satisfying a PSI criterion, wherein the first PDU set includes one or more PDUs carrying a payload of one unit of information at an application level;
receiving, a second command to cancel the PSI-based discard at the UE; and
transmitting, in response to the second command, a second PDU set irrespective of a PSI level of the second PDU set satisfy the PSI criterion.

11. The apparatus of claim 10, wherein the payload in the discarded first PDU set is associated with an extended reality application.

12. The apparatus of claim 10, configured to receive a control PDU including a flag value indicating the second command.

13. The apparatus of claim 12, wherein the control PDU is a designated control PDU specific for PSI-based discard cancellation.

14. The apparatus of claim 12, wherein the control PDU further includes a timer value indicating a duration during which the PSI-based discard is to be cancelled.

15. The apparatus of claim 10, configured to receive, by the UE, a control PDU including a threshold PSI value set to a highest allowable PSI value to indicate the second command to cancel of the PSI-based discard.

16. The apparatus of claim 10, configured to: receive a packet data convergence protocol (PDCP) control PDU including the second command.

17. The apparatus of claim 10, configured to receive an indication of the PSI criterion including a threshold PSI and an indication of a duration during which the PSI-based discard is to be activated.

18. A method comprising:
transmitting, by a network apparatus to a user equipment (UE) based on a first condition, a first command to activate a protocol data unit set importance (PSI)-based discard at the UE, wherein the PSI-based discard includes discarding a protocol data unit (PDU) set based on a PSI level of the PDU set satisfying a PSI criterion, and wherein the PDU set includes one or more PDUs carrying a payload of one unit of information at an application level; and
transmitting, by the network apparatus to the UE based on a second condition, a second command to cancel the PSI-based discard at the UE.

19. A method comprising:
receiving, by user equipment (UE), a first command to activate a protocol data unit set importance (PSI)-based discard at the UE;
discarding, by the UE in response to the first command, a first protocol data unit (PDU) set based at least on a PSI level of the first PDU set satisfying a PSI criterion, wherein the first PDU set includes one or more PDUs carrying a payload of one unit of information at an application level;
receiving, by the UE a second command to cancel the PSI-based discard at the UE; and
transmitting, by the UE in response to the second command, a second PDU set irrespective of a PSI level of the second PDU set satisfy the PSI criterion.
